(19) United States
(12) Patent Application Publication
(10) Pub. No.: US 2026/0119627 A1
(43) Pub. Date: Apr. 30, 2026

(54) SYSTEM AND METHOD FOR UTILIZING EVENT DATA TO DETERMINE A USER PERSONA

(71) Applicant: State Farm Mutual Automobile Insurance Company, Bloomington, IL (US)

(72) Inventors: Kevin KNIPMEYER, Sebastian, FL (US); Molly BONNEY, Mabank, TX (US); Olivia NAUMAN, Phoenix, AZ (US)

(73) Assignee: State Farm Mutual Automobile Insurance Company, Bloomington, IL (US)

(21) Appl. No.: 18/938,825

(22) Filed: Nov. 6, 2024

Related U.S. Application Data
(60) Provisional application No. 63/713,902, filed on Oct. 30, 2024.

(51) Int. Cl. G06F 21/31

(52) U.S. Cl. CPC G06F 21/316

(57) ABSTRACT

Systems and methods for analyzing event data to determine an event pattern, and then determining a user persona are disclosed. The method may include, such as by one or more processors: (i) receiving event data; (ii) determining an event mapping based upon the event data; (iii) converting the event mapping into an event numeric array; (iv) converting the event numeric array into an event vector; (v) receiving stored event vectors from data stores; (vi) inputting the stored event vectors and the event vector into trained machine-learning models; (vii) receiving a predicted scenario vector from the trained machine-learning models; (viii) receiving stored scenario vectors from the data stores; (ix) inputting the stored scenario vectors and the predicted scenario vector into the trained machine-learning models; (x) receiving a scenario embedding from the trained machine-learning models; (xi) predicting a persona marker based upon the scenario embedding; and/or (xii) outputting the persona marker.

### CROSS-REFERENCE TO RELATED APPLICATION

This patent application claims the benefit of priority to U.S. Provisional Application No. 63/713,902, filed on Oct. 30, 2024, the entirety of which is incorporated herein by reference.

### TECHNICAL FIELD

This present disclosure relates generally to the field of determining a user persona. In particular, the present disclosure relates to analyzing event data to determine an event pattern, and then using the event pattern to determine a user persona.

### BACKGROUND

With technology advancements, a person's interactions with computer systems have increased at an astounding rate. Many people now interact with a computer system almost constantly throughout the day. For example, there are a multitude of ways to collect data related to homes, vehicles, and the like, based upon a user's behavior and experiences.

Such interactions may include one-way interactions, or may include two-way interactions where the computer system may provide questions or prompts that are answered by a person during the interactions. Also, such interactions may result in data describing the various communications between a person and the computer systems.

This data may provide helpful insights into more effective forms of communication to achieve a desired end. However, deriving such insights may be challenging both in how such insights are identified, identified efficiently, and in confirming the accuracy of such derived insights. Conventional methods may further include additional ineffectiveness, encumbrances, inefficiencies, and other drawbacks.

### SUMMARY

The present embodiments may relate, inter alia, to the ability to analyze data related to a user's interactions, such as with the user's home, vehicles, and the like, in order to derive insights regarding more effective forms of communication. For instance, the computer systems and computer-implemented methods may relate to determining a user persona, such as those discussed above and elsewhere herein. Specifically, the present computer systems and computer-implemented methods may solve technical challenges by analyzing event data to determine an event pattern, and then using the event pattern to determine a user persona.

In one aspect, a computer-implemented method for analyzing event data to determine an event pattern, and then determining a user persona based upon the event pattern may be provided. The computer-implemented method may be performed by one or more local or remote processors of a computing system in communication with one or more local or remote data sources. The computer-implemented method may be implemented via one or more local or remote processors, servers, transceivers, sensors, memory units, mobile devices, smart watches, smart contact lenses, smart glasses, smart vehicles, augmented reality glasses, virtual reality headsets, mixed or extended reality glasses or headsets, voice bots or chatbots, ChatGPT bots, InstructGPT bots, Codex bots, Google Bard bots, and/or other electronic or electrical components, which may be in wired or wireless communication with one another and/or each operate as an input and/or output device.

In one instance, the computer-implemented method may include, via one or more local or remote processors, transceivers, sensors, and/or other components: (i) receiving, by one or more processors, event data from one or more systems, wherein the event data may include a plurality of site events corresponding to a user; (ii) determining, by the one or more processors, an event mapping based upon the event data, wherein the event mapping corresponds to the plurality of site events; (iii) converting, by the one or more processors, the event mapping into an event numeric array; (iv) converting, by the one or more processors, the event numeric array into an event vector; (v) receiving, by the one or more processors, one or more stored event vectors from one or more data stores; (vi) inputting, by the one or more processors, the one or more stored event vectors and the event vector into one or more trained machine-learning models; (vii) in response to the inputting, receiving, by the one or more processors, a predicted scenario vector from the one or more trained machine-learning models; (viii) receiving, by the one or more processors, one or more stored scenario vectors from the one or more data stores; (ix) inputting, by the one or more processors, the one or more stored scenario vectors and the predicted scenario vector into the one or more trained machine-learning models; (x) in response to the inputting, receiving, by the one or more processors, a scenario embedding from the one or more trained machine-learning models; (xii) predicting, by the one or more processors, a persona marker for the user based upon the scenario embedding; and/or (xii) presenting, by the one or more processors, the persona marker to a user device. The method may include additional, less, or alternate functionality, including that discussed elsewhere herein.

In another aspect, a computer system for analyzing event data to determine an event pattern, and then determining a user persona based upon the event pattern may be provided. The computer system may include (i) a memory having processor-readable instructions stored therein; and/or (ii) one or more local or remote processors configured to access the memory and execute the processor-readable instructions, which when executed by the one or more processors configures the one or more processors to perform a plurality of functions. The computer system may be implemented via one or more local or remote processors, servers, transceivers, sensors, memory units, mobile devices, smart watches, smart contact lenses, smart glasses, smart vehicles, augmented reality glasses, virtual reality headsets, mixed or extended reality glasses or headsets, voice bots or chatbots, ChatGPT bots, InstructGPT bots, Codex bots, Google Bard bots, and/or other electronic or electrical components, which may be in wired or wireless communication with one another and/or each operate as an input and/or output device.

In one instance, the functions of the computer system may include (i) receiving, by the one or more processors, event data from one or more systems, wherein the event data may include a plurality of site events corresponding to a user; (ii) determining, by the one or more processors, an event mapping based upon the event data, wherein the event mapping corresponds to the plurality of site events; (iii) converting, by the one or more processors, the event mapping into an event numeric array; (iv) converting, by the one or more processors, the event numeric array into an event vector; (v) receiving, by the one or more processors, one or more stored event vectors from one or more data stores; (vi) inputting, by the one or more processors, the one or more stored event vectors and the event vector into one or more trained machine-learning models; (vii) in response to the inputting, receiving, by the one or more processors, a predicted scenario vector from the one or more trained machine-learning models; (viii) receiving, by the one or more processors, one or more stored scenario vectors from the one or more data stores; (ix) inputting, by the one or more processors, the one or more stored scenario vectors and the predicted scenario vector into the one or more trained machine-learning models; (x) in response to the inputting, receiving, by the one or more processors, a scenario embedding from the one or more trained machine-learning models; (xii) predicting, by the one or more processors, a persona marker for the user based upon the scenario embedding; and/or (xii) presenting, by the one or more processors, the persona marker to a user device. The functions may include additional, less, or alternate functionality, including that discussed elsewhere herein.

In an additional aspect, a non-transitory computer-readable medium containing instructions for analyzing event data to determine an event pattern, and then determining a user persona based upon the event pattern may be provided. The non-transitory computer-readable medium may be implemented via one or more local or remote processors, servers, transceivers, sensors, memory units, mobile devices, smart watches, smart contact lenses, smart glasses, smart vehicles, augmented reality glasses, virtual reality headsets, mixed or extended reality glasses or headsets, voice bots or chatbots, ChatGPT bots, InstructGPT bots, Codex bots, Google Bard bots, and/or other electronic or electrical components, which may be in wired or wireless communication with one another and/or each operate as an input and/or output device.

The instructions of the non-transitory computer readable medium may include (i) receiving, by the one or more processors, event data from one or more systems, wherein the event data may include a plurality of site events corresponding to a user; (ii) determining, by the one or more processors, an event mapping based upon the event data, wherein the event mapping corresponds to the plurality of site events; (iii) converting, by the one or more processors, the event mapping into an event numeric array; (iv) converting, by the one or more processors, the event numeric array into an event vector; (v) receiving, by the one or more processors, one or more stored event vectors from one or more data stores; (vi) inputting, by the one or more processors, the one or more stored event vectors and the event vector into one or more trained machine-learning models; (vii) in response to the inputting, receiving, by the one or more processors, a predicted scenario vector from the one or more trained machine-learning models; (viii) receiving, by the one or more processors, one or more stored scenario vectors from the one or more data stores; (ix) inputting, by the one or more processors, the one or more stored scenario vectors and the predicted scenario vector into the one or more trained machine-learning models; (x) in response to the inputting, receiving, by the one or more processors, a scenario embedding from the one or more trained machine-learning models; (xii) predicting, by the one or more processors, a persona marker for the user based upon the scenario embedding; and/or (xii) presenting, by the one or more processors, the persona marker to a user device. The instructions may include additional, less, or alternate functionality, including that discussed elsewhere herein.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 is a diagram showing an exemplary architecture diagram for analyzing event data to determine an event pattern, and then determining a user persona based upon the event pattern, according to one or more embodiments, according to certain aspects of the disclosure.

FIG. 2 is an exemplary flowchart of a computer-implemented or computer-based method for training a machine-learning model to determine a user persona, according to certain aspects of the disclosure.

FIG. 3 is an exemplary computer-implemented or computer-based diagram for predicting a persona enumeration, according to certain aspects of the disclosure.

FIG. 4 is an exemplary flowchart of a computer-implemented or computer-based method for exemplary logic that the machine-learning models may utilize to determine a persona, according to certain aspects of the disclosure.

FIG. 5 is an exemplary flowchart of a computer-implemented or computer-based method for analyzing event data to determine an event pattern, and then determining a user persona based upon the event pattern, according to certain aspects of the disclosure.

FIG. 6 shows an exemplary machine learning training flowchart.

FIG. 7 illustrates an implementation of an exemplary computer system that executes one or more techniques presented herein.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

The present embodiments may relate, inter alia, to computer systems and computer-implemented methods that may solve technical challenges by analyzing event data to determine an event pattern, and then using the event pattern to determine a user persona. By continuously analyzing event data, the system may employ machine-learning algorithms to detect patterns, and then using such patterns to determine a user's persona. These models may dynamically adapt to real-time feedback and prediction results, which may enable the system to continuously increase the accuracy of the predictions.

There are a multitude of ways to collect event data, which may be based upon a user's (e.g., a customer) behavior and experiences. For example, the event data may correspond to a user's interaction with a home security system that has many sensors. The home security system may capture event data that may describe how a user interacted with the sensors during a security event (e.g., a flood). However, it may be very difficult to utilize a user's actions described in the event data (e.g., a person's interaction with home security systems) to determine the user's persona or receptiveness regarding receiving different types of communication that may relate to the security event, products, mitigation tactics, and the like.

Conventional methods for addressing such a problem may include a person manually reviewing the available event data, or a subset of the available event data, to speculate upon a user's persona. Such methods may be subjective and error-prone. Additionally, conventional methods may also include relying upon feedback from the user (e.g., customer) to inform the system of how the user would like to receive communications. However, such methods may be time consuming, as well as burdensome for the user. Conventional methods may further include additional ineffectiveness, encumbrances, inefficiencies, and other drawbacks, as well.

As a result, a need exists for the ability to analyze event data in order to predict the different types of personas and communication preferences of users described in the event data.

### Exemplary System Architecture for Determining a User Persona

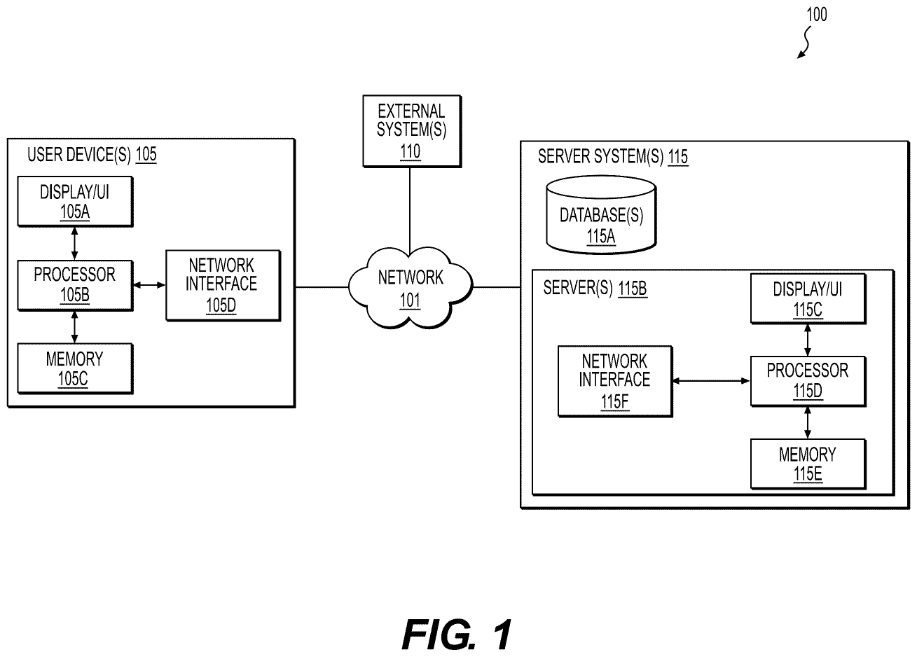

FIG. 1 depicts a diagram showing an exemplary architecture environment 100 for analyzing event data to determine an event pattern, and then determining a user persona based upon the event pattern, according to certain aspects of the disclosure. One or more user device(s) 105, one or more external system(s) 110, and one or more server system(s) 115 may communicate across a network 101. As will be discussed in further detail below, the one or more server system(s) 115 may communicate with one or more of the other components of the environment 100 across network 101. The one or more user device(s) 105 may be associated with a user, e.g., a user associated with one or more of generating, training, or tuning a deep learning model for analyzing event data to determine a user persona.

In some embodiments, the components of the environment 100 are associated with a common entity, e.g., an insurance company. In some embodiments, one or more of the components of the environment is associated with a different entity than another. The systems and devices of the environment 100 may communicate in any arrangement. As will be discussed herein, systems and/or devices of the environment 100 may communicate in order to one or more of generate, train, and/or use a machine-learning model to analyze event data to determine a user persona, among other activities.

The user device 105 may be configured to enable the user to access and/or interact with other systems in the environment 100. For example, the user device 105 may be a computer system such as, for example, a desktop computer, a mobile device, a tablet, etc. In some embodiments, the user device 105 may include one or more electronic application(s), e.g., a program, plugin, browser extension, etc., installed upon a memory of the user device 105.

The user device 105 may include a display/user interface (UI) 105A, a processor 105B, a memory 105C, and/or a network interface 105D. The user device 105 may execute, by the processor 105B, an operating system (O/S) and at least one electronic application (each stored in memory 105C). The electronic application may be a desktop program, a browser program, a web client, or a mobile application program (which may also be a browser program in a mobile O/S), an applicant specific program, system control software, system monitoring software, software development tools, or the like. For example, the environment 100 may extend information upon a web client that may be accessed through a web browser.

In some embodiments, the electronic application(s) may be associated with one or more of the other components in the environment 100. The application may manage the memory 105C, such as a database, to transmit streaming data to network 101. The display/UI 105A may be a touch screen or a display with other input systems (e.g., mouse, keyboard, etc.) so that the user(s) may interact with the application and/or the O/S. The network interface 105D may be a TCP/IP network interface for, e.g., Ethernet or wireless communications with the network 101. The processor 105B, while executing the application, may generate data and/or receive user inputs from the display/UI 105A and/or receive/transmit messages to the server system 115, and may further perform one or more operations prior to providing an output to the network 101.

External systems 110 may be, for example, one or more third party and/or auxiliary systems that integrate and/or communicate with the server system 115 in performing various query analysis tasks. External systems 110 may be in communication with other device(s) or system(s) in the environment 100 over the one or more networks 101. For example, external systems 110 may communicate with the server system 115 via API (application programming interface) access over the one or more networks 101, and also communicate with the user device(s) 105 via web browser access over the one or more networks 101.

In various embodiments, the network 101 may be a wide area network (“WAN”), a local area network (“LAN”), a personal area network (“PAN”), or the like. In some embodiments, network 101 may include the Internet, and information and data provided between various systems occurs online. “Online” may mean connecting to or accessing source data or information from a location remote from other devices or networks coupled to the Internet.

Alternatively, “online” may refer to connecting or accessing a network (wired or wireless) via a mobile communications network or device. The Internet is a worldwide system of computer networks—a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like.

The server system 115 may include an electronic data system, e.g., a computer-readable memory such as a hard drive, flash drive, disk, etc. In some embodiments, the server system 115 may include and/or interacts with an application programming interface for exchanging data to other systems, e.g., one or more of the other components of the environment.

The server system 115 may include a database 115A and at least one server 115B. The server system 115 may be a computer, system of computers (e.g., rack server(s)), and/or or a cloud service computer system. The server system may store or have access to database 115A (e.g., hosted upon a third party server or in memory 115E). The server(s) may include a display/UI 115C, a processor 115D, a memory 115E, and/or a network interface 115F. The display/UI 115C may be a touch screen or a display with other input systems (e.g., mouse, keyboard, etc.) for an operator of the server 115B to control the functions of the server 115B. The server system 115 may execute, by the processor 115D, an operating system (O/S) and at least one instance of a servlet program (each stored in memory 115E).

The server system 115 may generate, store, train, or use a deep learning model configured to analyze event data to determine a user persona. The server system 115 may include a deep learning model and/or instructions associated with the deep learning model, e.g., instructions for generating a deep learning model, training the deep learning model, using the deep learning model, etc. The server system 115 may include training data, e.g., event data, scenario data, user personas, and the like.

In some embodiments, a system or device other than the server system 115 is used to generate and/or train the deep learning model. For example, such a system may include instructions for generating the deep learning model, the training data and ground truth, and/or instructions for training the deep learning model. A resulting trained deep learning model may then be provided to the server system 115.

Generally, a deep learning model may include a set of variables, e.g., nodes, neurons, filters, etc., that are tuned, e.g., weighted or biased, to different values via the application of training data. In supervised learning, e.g., where a ground truth is known for the training data provided, training may proceed by feeding a sample of training data into a model with variables set at initialized values, e.g., at random, based upon Gaussian noise, a pre-trained model, or the like. The output may be compared with the ground truth to determine an error, which may then be back-propagated through the model to adjust the values of the variable.

Training may be conducted in any suitable manner, e.g., in batches, and may include any suitable training methodology, e.g., stochastic or non-stochastic gradient descent, gradient boosting, random forest, etc. In some embodiments, a portion of the training data may be withheld during training and/or used to validate the trained machine-learning model, e.g., compare the output of the trained model with the ground truth for that portion of the training data to evaluate an accuracy of the trained model. The training of the machine-learning model may be configured to cause the machine-learning model to learn associations between the event data and user persona, such that the trained deep learning model is configured to determine a user persona in response to the input event data based upon the learned associations.

In various embodiments, the variables of a deep learning model may be interrelated in any suitable arrangement in order to generate the output. For instance, in some embodiments, the deep learning model may include signal processing architecture that is configured to identify, isolate, and/or extract features, patterns, and/or structure in a text. For example, the deep learning model may include one or more convolutional neural network (“CNN”) configured to identify features in the document information data, and may include further architecture, e.g., a connected layer, neural network, etc., configured to identify a user persona.

Although depicted as separate components in FIG. 1, it should be understood that a component or portion of a component in the environment 100 may, in some embodiments, be integrated with or incorporated into one or more other components. For example, a portion of the display 115C may be integrated into the user device 105 or the like. In various embodiments, operations or aspects of one or more of the components discussed above may be distributed amongst one or more other components. Any suitable arrangement and/or integration of the various systems and devices of the environment 100 may be used.

Further aspects of the machine-learning model and/or how it may be utilized to identify a high-quality user search query are discussed in further detail in the methods above. In these methods, various acts may be described as performed or executed by a component from FIG. 1, such as the server system 115, the user device 105, or components thereof. However, it should be understood that in various embodiments, various components of the environment 100 discussed above may execute instructions or perform acts including the acts discussed above and below. An act performed by a device may be considered to be performed by a processor, actuator, or the like associated with that device. Further, it should be understood that in various embodiments, various steps may be added, omitted, and/or rearranged in any suitable manner.

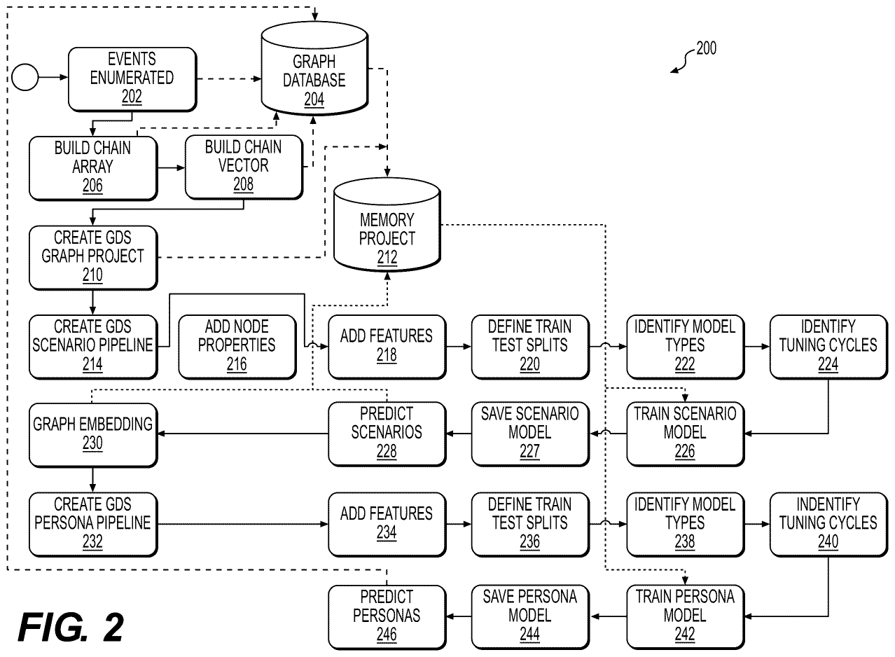

In general, any process or operation discussed in this disclosure that is understood to be computer-implementable, such as the processes illustrated in FIGS. 2-6, may be performed by one or more processors of a computer system, such any of the systems or devices in the environment 100 of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

### Exemplary Determining a User Persona Flowchart

FIG. 2 is an exemplary flowchart of a computer-implemented or computer-based method for training a machine-learning model to determine a user persona, according to certain aspects of the disclosure. In one instance, the user device 105, the server system 115, and/or the external systems 110 may perform one or more portions of the process 200 and are implemented using, for instance, a chip set including a processor (e.g., processor 115D) and a memory (e.g., memory 115E) as shown in FIG. 1. As such, the user device 105, the server system 115, and/or the external systems 110 may be configured to facilitate accomplishing various parts of the process 200, as well as accomplishing embodiments of other processes described herein in conjunction with other components of the system 100. Although the process 200 is illustrated and described as a sequence of actions, operations, and/or functionality, it is contemplated that various embodiments of the process 200 may be performed in any order or combination and need not include all of the illustrated actions, operations, and/or functionality.

In block 202, the server system may receive event data and enumerate the data (e.g., perform a fixed enumeration of event descriptions). For example, the system may collect numeric fields and/or convert strings into enumerated values or encode the values all into a large flat table.

In block 204, the system may store the enumerated event data in a database (e.g., a graph database, database(s) 115A). The database may store the enumerated event data for future training, analysis, and the like. The enumerated event data may be stored as a series of nodes, where each node may correspond to an event that is included in the event data. The nodes may include default values for each of the node properties.

The enumerated event data may include a plurality of labels and/or a plurality of probabilities. The label may describe an event type for each event. The probability may correspond to a probability for each node of a particular type of event following the node. In some embodiments, the system may utilize a machine-learning model to predict the probabilities. The system may utilize the probabilities to create scenario chains (e.g., sequences of scenarios that include one or more events).

In block 206, the system may build a chain array based upon the enumerated event data. In some embodiments, the system may retrieve additional data from the database, where the additional data may be included in the chain array. The chain array may include one or more arrays, where each array may correspond to an event described by the event data. The chain array may include the nodes, labels, and/or probabilities. The chain array may have a variable length that corresponds to the amount and type of enumerated event data. Each array may include a variable length of values. Additionally, the chain array may include a variable length of the number of arrays included in the chain array. The system may store the chain array in the database (block 204).

In block 208, the system may convert the chain array into a chain vector (e.g., using a graph embedding process). The chain vector may include one or more vectors, where each vector may correspond to an array in the chain array. Each vector may include a fixed length of values, where the fixed length may be compatible with one or more machine-learning models. The chain vector may include the nodes, labels, and/or probabilities. Additionally, the chain vector may include a fixed length of vectors, where the fixed length may be compatible with one or more machine-learning models. The system may store the chain vector in the database (block 204).

In block 210, the system may create a memory space (e.g., in the form of a Graph Data Science (CDS) graph project) for some or all of the event data, chain array, and/or chain vector.

In block 212, the system may store the memory space, the event data, the chain array, and/or the chain vector in a database (e.g., a memory project database, database(s) 115A). The memory project may store previously received event data, previous chain arrays, and/or previous chain vectors.

In block 214, the system may create a pipeline (e.g., a CDS scenario pipeline). In block 216, the system may add one or more node properties to be generated in the pipeline created in block 214. The node properties may include any transformation as needed to derive the features for use in the pipeline created in block 214.

In block 218, the system may add features to the pipeline created in block 214. For example, one or more features may be identified and added as inputs and targets for the machine-learning model. The features may be converted using an embedding process. For example, the system may use a graph embedding process that may include unique types of aggregation functions, which may be based upon collecting and condensing a variable number of nodes and/or node relationships for a number of iterations into an embedded vector.

In block 220, the system may define training test splits. For example, the system may split the memory project into subsets of multiple data sets for multiple training iterations against a test data set.

In block 222, the system may identify one or more machine-learning model types to perform the training for predicting a scenario. A user may specify the machine-learning model types. Additionally, or alternatively, the system may automatically identify the machine-learning model types.

In block 224, the system may identify one or more tuning cycles for the training process. A user may specify the tuning cycles. Additionally, or alternatively, the system may automatically identify the tuning cycles.

In block 226, the system may train the scenario machine-learning model to predict scenarios based upon the event data. The system may train the scenario machine-learning model based upon at least one of: the event data, the chain array, the chain vector, previously stored event data, previously stored array chains, and/or previously stored chain vectors. Additionally, the system may train the scenario machine-learning model based upon the training test splits, machine-learning model types, and/or the tuning cycles.

In block 227, the system may save the scenario machine-learning model in a database (e.g., a graph database, database(s) 115A). In some embodiments, the saving may include updating a previously saved scenario machine-learning model.

In block 228, the system may utilize the machine-learning model to predict a scenario of a previously saved chain vector. As discussed above, the chain vector may include one or more vectors that each correspond to an event. The system may retrieve one or more chain vectors from the memory project (block 212) and input the chain vectors into the machine-learning model. In response to the inputting, the machine-learning model may output a predicted scenario to the system in the form of a scenario vector (e.g., a graph embedding). In various embodiments, the system may work the nodes and relationships with a hash to incorporate aspects of the node properties and relationship patterns between the nodes into a vector.

In block 230, the system may receive the scenario vector that was output from the machine-learning model. The system may store the scenario vector in the memory project (e.g., 212) for future training and/or analysis.

In block 232, the system may create a pipeline to predict the persona (e.g., a GDS persona pipeline) of a user.

In block 234, the system may add features to the scenario pipeline. For example, one or more features may be identified and added as inputs and targets for the machine-learning model.

In various embodiments, the features may be converted using an embedding process. For example, the system may use a graph embedding process that may include unique types of aggregation functions, which may be based upon collecting and condensing a variable number of nodes and/or node relationships for a number of iterations into a scenario vector and used as a feature of the pipeline.

In block 236, the system may define training test splits. For example, the system may split the memory project into subsets of data for training and iterate for evaluation against a testing data subset.

In block 238, the system may identify one or more machine-learning model types to perform the training for predicting a persona. A user may specify the machine-learning model types. Additionally, or alternatively, the system may automatically identify the machine-learning model types. One or more model types may be evaluated during the training process.

In block 240, the system may identify one or more tuning cycles for the training process. A user may specify the number of tuning cycles. Additionally, or alternatively, the system may automatically identify the tuning cycles.

In block 242, the system may train the persona machine-learning model to predict a persona based upon the scenario vector. In some embodiments, the training may result in returning a prediction and a confidence score along with the original target for comparison.

The system may train the persona machine-learning model based upon at least one of the following input data: the event data, the chain array, the chain vector, the scenario vector, previously stored event data, previously stored array chains, previously stored chain vectors, and/or previously stored scenario vectors. Additionally, the system may train the persona machine-learning model based upon the training test splits, machine-learning model types, and/or the tuning cycles. The persona machine-learning model may be configured to analyze the received input data, learn one or more associations between the input data, and output a predicted persona.

In block 244, the system may save the persona machine-learning model in a database (e.g., a graph database, database(s) 115A). In some embodiments, the saving may include updating a previously saved persona machine-learning model.

In block 246, the system may utilize the stored persona machine-learning model to predict a persona based upon the input data. For example, the system may receive an output persona from the persona machine-learning model. The system may also save the predicted persona in the database (block 204), where the predicted persona may be utilized for future training (e.g., to train the persona machine-learning model in block 242).

### Exemplary Persona Enumeration Prediction Diagram

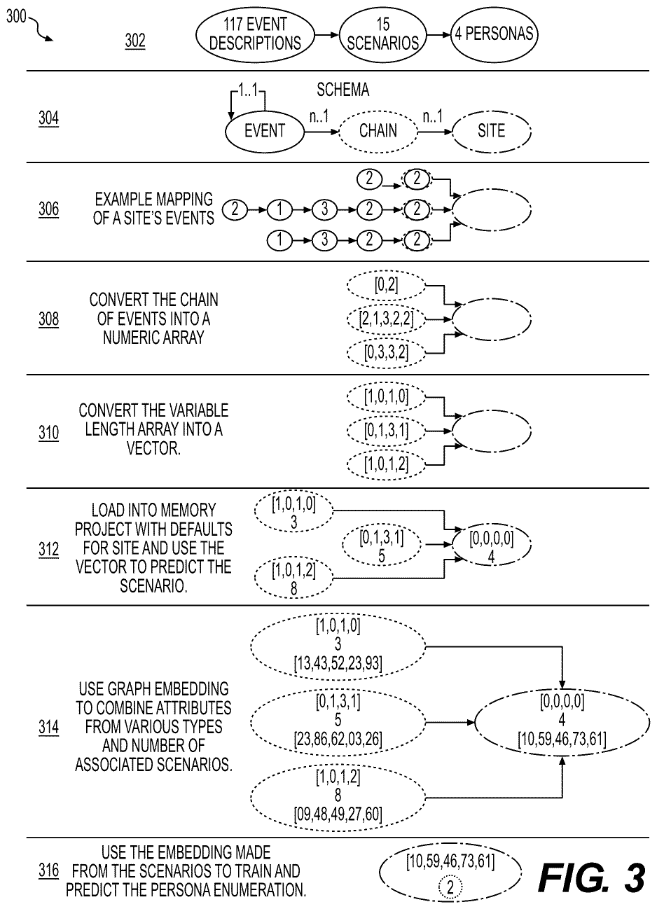

FIG. 3 is an exemplary computer-implemented or computer-based diagram 300 for predicting a persona enumeration, according to certain embodiments. In one instance, the user device 105, the server system 115, and/or the external systems 110 may perform one or more portions of the diagram 300 and are implemented using, for instance, a chip set including a processor (e.g., processor 115D) and a memory (e.g., memory 115E) as shown in FIG. 1. As such, the user device 105, the server system 115, and/or the external systems 110 may be configured to facilitate accomplishing various parts of the diagram 300, as well as accomplishing embodiments of other processes described herein in conjunction with other components of the system 100. Although the diagram 300 is illustrated and described as a sequence of actions, operations, and/or functionality, it is contemplated that various embodiments of the diagram 300 may be performed in any order or combination and need not include all of the illustrated actions, operations, and/or functionality.

As shown in block 302, and as discussed above, the system may analyze event data to determine events and corresponding labels (e.g., event descriptions). The system may then analyze the event descriptions to determine one or more scenarios that include a subset of the events. The system may further analyze the scenarios to determine one or more personas, where each persona may correspond to a persona of a user.

The system may utilize a particular schema, which may include events that make up event chains, where the event chains may be identified as probable scenarios. The scenarios may make up scenario chains, which may correspond to sites, as shown in block 304.

The events may be represented as an event mapping, as shown in block 306. The event mapping may include more than one chain of events, where each chain may include at least one event. For example, three chains of events are shown in the event mapping, where each chain may include a numeric value that corresponds to an event that took place in the chain. The first chain man include “0” and “2.” The second chain may include “2,” “1,” “3,” “2,” and “2.” The third chain may include “0,” “3,” “3,” and “2.”

The system may convert the chain of events into a variable length numeric array, as shown in block 308. For example, each chain of events may be converted into a numeric array. The first array may include [0, 2], the second array may include [2, 1, 3, 2, 2], and the third array may include [0, 3, 3, 2].

The system may convert the variable length numeric array into a chain vector, as shown in block 310. For example, the first array may be converted to the first vector that may include [1, 0, 1, 0], the second array may be converted into a second vector that may include [0, 1, 3, 1], and the third array may be converted into a third vector that may include [1, 0, 1, 2].

The system may load the vector into a memory (e.g., memory project), where the vector may include default values (e.g., default values that correspond to a site node), as shown in block 312. For example, as shown in block 312, the default site value for the first vector may include “3,” the default site value for the second vector may include “5,” and the default site value for the third vector may include “8.”

Further, the system may use the vector to predict a scenario vector, as also shown in block 312. For example, as shown in block 312, the predicted scenario vector may include [0, 0, 0, 0] and a predicted site value of “4.”

The system may use a graph embedding to combine attributes from various other scenarios, as shown in block 314. The system may retrieve scenario data from a database e.g., a graph database, database(s) 115A), where the scenario data may correspond to scenarios that have similar attributes as the predicted scenario.

As shown in block 314, the first vector may include [13, 43, 52, 23, 93] as additional values, the second vector may include [23, 86, 62, 03, 26] as additional values, and the third vector may include [09, 48, 49, 27, 60] as additional values. The graph embedding process may analyze the vectors to predict [10, 59, 46, 73, 61] as the graph embedding.

The system may use the graph embedding from the scenarios to train and predict the persona enumeration, as shown in block 316. For example, the graph embedding may be input into a trained machine-learning model, where the trained machine-learning model may be configured to predict a persona enumeration (e.g., “2”) based upon the graph embedding. The persona enumeration may correspond to a persona label (e.g., receptive, self-sufficient, ambivalent, or resistant). The system may then transmit the personal label to an internal and/or external system for generating a communication based upon the persona label, and then sending the communication to one or more users.

### Exemplary Machine-Learning Model Logic Flowchart

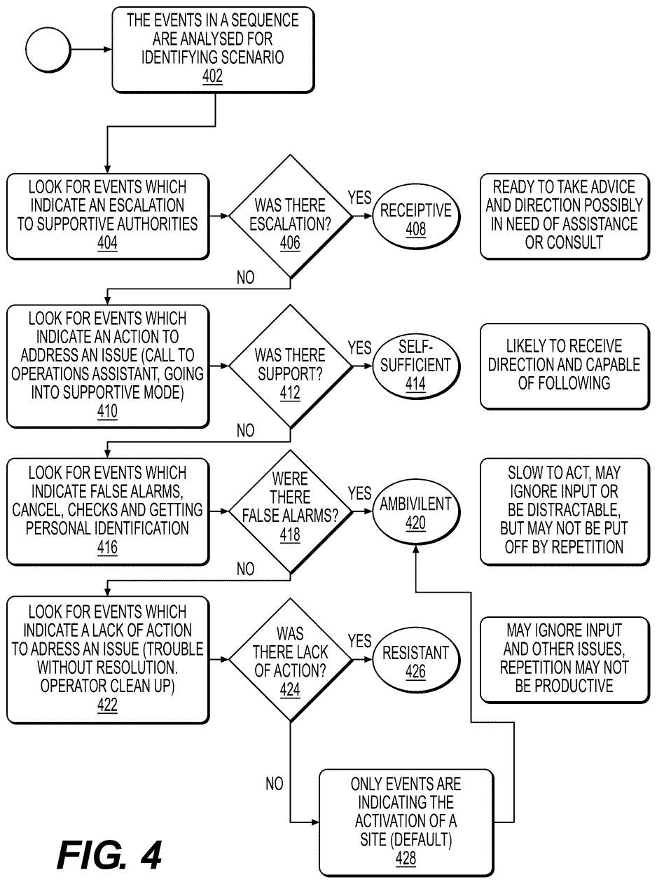

FIG. 4 is an exemplary flowchart of a computer-implemented or computer-based method 400 for exemplary logic that one or more machine-learning models may utilize to determine a persona, according to certain aspects of the disclosure. In one instance, the user device 105, the server system 115, and/or the external systems 110 may perform one or more portions of the method 400 and are implemented using, for instance, a chip set including a processor (e.g., processor 115D) and a memory (e.g., memory 115E) as shown in FIG. 1. As such, the user device 105, the server system 115, and/or the external systems 110 may be configured to facilitate accomplishing various parts of the method 400, as well as accomplishing embodiments of other processes described herein in conjunction with other components of the system 100. Although the method 400 is illustrated and described as a sequence of actions, operations, and/or functionality, it is contemplated that various embodiments of the method 400 may be performed in any order or combination and need not include all of the illustrated actions, operations, and/or functionality.

The system may analyze received event data for a sequence of events, where the sequence of events may be further analyzed to determine a scenario (block 402). The previous sections describe exemplary processes for identifying a scenario.

The system may analyze the event data to determine which (if any) events indicate an escalation to supportive authorities (e.g., police, ambulance, security services) (blocks 404 and 406).

If the events do indicate an escalation to supportive authorities, the system may determine that the user has a receptive persona (block 408). The receptive persona may correspond to a user who is ready to take advice and direction, and who possibly be in need of assistance or consult.

If the events do not indicate an escalation to supportive authorities, the system may analyze the event data to determine if any events indicate an action to address an issue (e.g., call an operations assistant, going into supportive mode) (block 410).

If there was support to address the issue, the system may determine that the user has a self-sufficient persona (blocks 412 and 414). The self-sufficient persona may correspond to a user who is likely to receive direction and capable of following such direction.

If there was not support, the system may analyze the event data to determine if any events indicate false alarms, canceled alarms, checks, and/or getting personal information (block 416).

If there were false alarms, the system may determine that the user has an ambivalent persona (blocks 418 and 420). The ambivalent persona may correspond to a user who is slow to act, may ignore input or be distractible, but may not be put off by repetition.

If there were not false alarms, the system may analyze the event data to determine if any events indicate a lack of action to address an issue (e.g., trouble without resolution, operator clean up) (block 422).

If there was a lack of action, the system may determine that the user has a resistant persona (blocks 424 and 426). The resistant persona may correspond to a user who may ignore input and other issues, where repetition may not be productive.

If there was not a lack of action, the system may determine that the events only include events that indicate the activation of a site (e.g., default value) and the user may have an ambivalent persona (blocks 428 and 420).

### Exemplary Determining a User Persona Flowchart

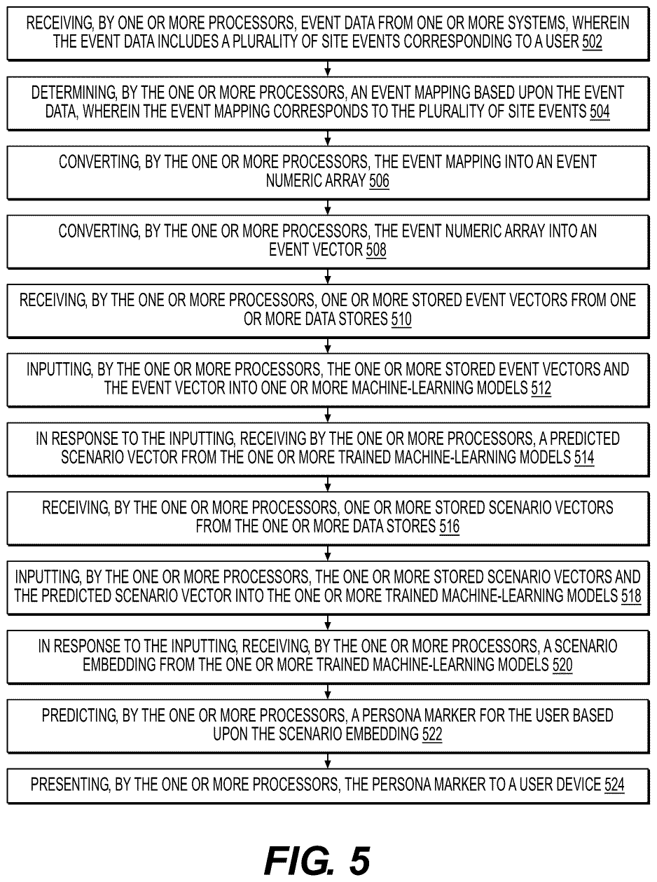

FIG. 5 is an exemplary flowchart of a computer-implemented or computer-based method 500 for analyzing event data to determine an event pattern, and then determining a user persona based upon the event pattern, according to certain aspects of the disclosure. In one instance, the user device 105, the server system 115, and/or the external systems 110 may perform one or more portions of the computer-implemented method 500 and are implemented using, for instance, a chip set including a processor (e.g., processor 115D) and a memory (e.g., memory 115E) as shown in FIG. 5.

As such, the user device 105, the server system 115, and/or the external systems 110 may be configured to facilitate accomplishing various parts of the computer-implemented method 500, as well as accomplishing embodiments of other processes described herein in conjunction with other components of the system 100. Although the computer-implemented method 500 is illustrated and described as a sequence of actions, operations, and/or functionality, it is contemplated that various embodiments of the computer-implemented method 500 may be performed in any order or combination and need not include all of the illustrated actions, operations, and/or functionality.

The computer-implemented method 500 may include receiving, by one or more processors, event data from one or more systems, wherein the event data may include a plurality of site events corresponding to a user (e.g., block 502). The one or more systems may correspond to internal and/or external systems. In some embodiments, the event data may be directly input into the system via a user interface (e.g., display/UI 105A) and/or the system may retrieve the event data from one or more data stores (e.g., data stores of the one or more systems). The site events may correspond to events at the user's home, car, and the like. For example, the site events may correspond to events when the user's security system was activated, triggered, or deactivated. Additionally, or alternatively, the site events may correspond to when the user's car is in an accident, receives a ticket, is damaged, and the like.

The computer-implemented method 500 may include determining, by the one or more processors, an event mapping based upon the event data (e.g., block 504). The event mapping may correspond to the plurality of site events. The event mapping may include a plurality of nodes. Additionally, each of the plurality of nodes may correspond to at least one of the plurality of site events. Each node may include one or more attributes that describe the node. Example attributes include a unique identifier, a name, an age, a location, a type (e.g., person, place, thing), and the like.

In some embodiments, determining the event mapping may include enumerating the event data. For example, enumerating the event data may allow for the event data to be input and analyzed by one or more machine-learning models. The enumerated event data may be loaded into one or more data stores for future reference and analysis.

In various embodiments, determining the event mapping may further include: (i) correlating, by the one or more processors, each of the plurality of nodes by identifying a connection between each of the plurality of nodes, wherein the correlating may include determining a node sequence; (ii) predicting, by the one or more processors, at least one label for each of the plurality of nodes, wherein the at least one label corresponds to an event definition; (iii) determining, by the one or more processors, at least one event probability for each of the plurality of nodes; and/or (iv) storing, by the one or more processors, the correlated plurality of nodes, the at least one label for each of the plurality of nodes, and the at least one event probability for each of the plurality of nodes in the one or more data stores.

Identifying a connection between each of the plurality of nodes may include analyzing the event data based upon one or more rules. Exemplary rules for analyzing the event data may include one or more of the following: (i) identifying events that may indicate an escalation to supportive authorities; (ii) identifying events which may indicate an action to address an issue (e.g., calling an operations assistant, going into supportive mode); and/or (iii) identifying events which may indicate false alarms, cancellations, checks, and/or gathering personal information. For example, the connections may correspond to relationships, actions, events within a scenario, actors, and the like.

In various embodiments, predicting the at least one label for each of the plurality of nodes may include utilizing, by the one or more processors, a Graph Neural Network to perform the predicting of the at least one label for each of the plurality of nodes. The label may include an event definition, where the event definition may correspond to a scenario for the one or more events. In some embodiments, a Graph Neural Network (GNN) may predict the label of scenarios and personas.

In some embodiments, determining the at least one event probability for each of the plurality of nodes may further include deriving, by the one or more processors, one or more probability maps from the correlated plurality of nodes. For example, one or more machine-learning models (e.g., a Bayesian Network) may build a probability network based upon the existing events (e.g., the correlated plurality of nodes and/or the label for each of the plurality of nodes). The probability network may include probability links between scenarios found in the event data. The system may initially create the probability links based upon the time that the scenario occurred, where the system may update the probability links based upon updated probability data (e.g., probability predictions from a machine-learning model).

The correlated plurality of nodes and/or the corresponding labels may be stored in one or more data stores, where the data stores may correspond to a graph database. The graph database may store the data, as well as one or more connections between the data points (e.g., nodes), as well as allow for the querying of relationships between the nodes. The stored nodes and/or labels may be used for future training of the machine-learning models.

The computer-implemented method 500 may include converting, by the one or more processors, the event mapping into an event numeric array (e.g., block 506). The event numeric array may include a variable length. The conversion process may described in further detail in relation to FIG. 3.

The computer-implemented method 500 may include converting, by the one or more processors, the event numeric array into an event vector (e.g., block 508). The event vector may include a standard length. For example, the event vector may include padding so that each vector has a standard length. The conversion process may described in further detail in relation to FIG. 3.

The computer-implemented method 500 may include receiving, by the one or more processors, one or more stored event vectors from one or more data stores (e.g., block 510). The stored event vectors may correspond to previous event mappings of the user. For example, the event vectors may correspond to previous events of the user's security system, where the current event vector also corresponds to events of the user's security system.

The computer-implemented method 500 may include inputting, by the one or more processors, the one or more stored event vectors and the event vector into one or more trained machine-learning models (e.g., block 512). The trained machine-learning models may have been previously trained to predict a scenario based upon one or more event vectors. Additionally, each of the stored event vectors and the current event vector may include one or more nodes and/or properties.

The computer-implemented method 500 may include, in response to the inputting, receiving, by the one or more processors, a predicted scenario vector from the one or more trained machine-learning models (e.g., block 514). The trained machine-learning models may analyze the received stored event vectors and the event vector, analyze all of the vectors to determine the predicted scenario vector, and then output the predicted scenario vector.

The computer-implemented method 500 may include receiving, by the one or more processors, one or more stored scenario vectors from the one or more data stores (e.g., block 516). The stored scenario vectors may correspond to previous scenarios of the user. For example, the scenario vectors may correspond to previous scenarios of the user's security system, where the predicted scenario vector also corresponds to scenarios of the user's security system.

The computer-implemented method 500 may include inputting, by the one or more processors, the one or more stored scenario vectors and the predicted scenario vector into the one or more trained machine-learning models (e.g., block 518). The trained machine-learning models may have been previously trained to determine a scenario embedding based upon one or more stored scenario vectors and a predicted scenario vector.

The computer-implemented method 500 may include, in response to the inputting, receiving, by the one or more processors, a scenario embedding from the one or more trained machine-learning models (e.g., block 520). For example, the scenario embedding may correspond to a graph embedding representation of the predicted scenario.

The computer-implemented method 500 may include predicting, by the one or more processors, a persona marker for the user based upon the scenario embedding (e.g., block 522). The persona marker may correspond to the type of persona for the user. For example, the persona marker may include a resistant marker, an ambivalent marker, a self-sufficient marker, or a receptive marker. The resistant marker may correspond to a user that may have persona that may ignore input and other issues and/or where repetitive feedback may not be productive. The ambivalent marker may correspond to a user that may have a persona that may be slow to act, may ignore input or be distractible, but may not be put off by repetitive feedback. The self-sufficient marker may correspond to a user who may have a persona that may be likely to receive direction and capable of following such direction. The receptive marker may correspond to a user who may have a persona that is ready to take advice and direction and/or may possibly be in need of assistance or consult.

For example, the one or more trained machine-learning models may analyze the scenario embedding, including the various attributes (e.g., nodes and/or properties) of the scenario embedding, to predict a persona marker (e.g., a persona enumeration).

The computer-implemented method 500 may include presenting, by the one or more processors, the persona marker to a user device (e.g., block 524). The presenting may include outputting, by the one or more processors, the persona marker to a user interface of the user device. The user interface may display a notification that may include a description of the persona marker (e.g., resistant persona, ambivalent persona, self-sufficient person, or receptive persona). In some embodiments, the user interface may output the persona marker and one or more widgets. Upon selection, a widget may initiate a communication with another device and/or system, where the communication may include the persona marker. For example, upon selection, the widget may send the persona marker to another system, where the receiving system may store the persona marker.

Additionally, or alternatively, presenting the persona marker may include otherwise visually and/or audibly (or verbally) presenting the persona market to a user via one or more user devices, such as a mobile device equipped with a voice bot or chat bot.

In various embodiments, the computer-implemented method 500 may include: (i) sending, by the one or more processors, the persona marker to a data store; (ii) in response to the sending, receiving, by the one or more processors, a persona template from the data store, wherein the persona template corresponds to the persona marker; (iii) creating, by the one or more processors, an electronic communication based upon the persona template; and/or (iv) sending, by the one or more processors, the electronic communication to the user device.

Further, in some embodiments, the computer-implemented method 500 may include: (i) inputting, by the one or more processors, the persona marker into a trained machine-learning model, wherein the trained machine-learning model is configured to create an electronic communication based upon the persona marker; (ii) receiving, by the one or more processors, the electronic communication from the trained machine-learning model; and/or (iii) sending, by the one or more processors, the electronic communication to the user device.

As discussed above, the persona marker may be sent to the data store in response to the selection of a widget. Additionally, or alternatively, the persona marker may automatically be sent to the data store. For example, in some embodiments, the computer-implemented method 500 may bypass outputting the persona to the user interface and may automatically send the persona marker to the data store.

In response to receiving the persona marker, the data store may retrieve a persona template that corresponds to the persona marker. For example, the persona marker may include a unique persona identifier that corresponds to the persona template. The persona template may include rules that indicate specifics of how a communication to the user should be created. For example, the rules may correspond to particular words that should or should not be included in the communication. Additionally, or alternatively, the rules may correspond to the structure of the communication, a tone of the communication, one or more images that should or should not be included in the communication, a frequency of when communications should be sent to the user, and the like.

The computer-implemented method 500 may include creating an electronic communication (e.g., an email, text message, chat message, and the like) based upon the persona template. For example, the system my utilize one or more machine-learning models to create the electronic communication. The machine-learning models may receive and analyze the event vector, the persona marker, the scenario embedding, and/or the persona template to create an electronic communication. The machine-learning models may output the electronic communication, where the electronic communication may include text, images, sounds, and the like.

The computer-implemented method 500 may include sending the electronic communication to the user device. The sending may responsive to the creation of the electronic communication. For example, a machine-learning model may create and output the electronic communication, where the system may send the electronic communication to the user device once the electronic communication has been output. The electronic communication may be sent to the user device in the form of a text, email, chat message, and the like.

In some embodiments, the computer-implemented method 500 may include: (i) receiving, by the one or more processors, a feedback indicator from the user device, wherein the feedback indicator corresponds to an accuracy of the persona marker; and/or (ii) tuning, by the one or more processors, the one or more trained machine-learning models based upon the feedback indicator.

The electronic communication may include a feedback indicator, where the feedback indicator may include a widget for receiving feedback from the user. The feedback indicator may correspond to the accuracy of the persona marker. For example, the feedback indicator may include a thumbs up widget and a thumbs down widget, with a displayed question stating “How would you rate the tone of this message?” The user may select the appropriate widget to provide feedback to the system.

Upon receiving the feedback, the system may use the feedback to tune the one or more trained machine-learning models. For example, the tuning may include inputting the feedback, the event vector, the persona marker, the scenario embedding, and/or the persona template into the trained machine-learning model, where the trained machine-learning model may analyze such inputs.

### Exemplary Machine Learning Techniques

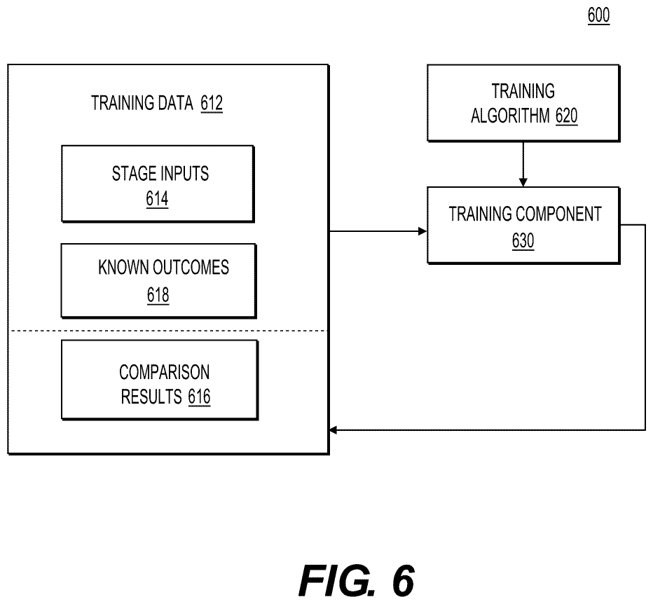

One or more implementations disclosed herein include and/or may be implemented using a machine-learning model. For example, one or more of the server systems 115 may be implemented using a machine-learning model and/or may be used to train the machine-learning model. A given machine-learning model may be trained using the data flow 600 of FIG. 6. Training data 612 may include one or more of stage inputs 614 and known outcomes 618 related to the machine-learning model to be trained. The stage inputs 614 may be from any applicable source including text, visual representations, data, values, comparisons, stage outputs, e.g., one or more outputs from one or more actions or operations from FIGS. 2-5. The known outcomes 618 may be included for the machine-learning models generated based upon supervised or semi-supervised training. An unsupervised machine-learning model may not be trained using known outcomes 618. Known outcomes 618 may include known or desired outputs for future inputs similar to or in the same category as stage inputs 614 that do not have corresponding known outputs.

The training data 612 and a training algorithm 620, e.g., one or more of the modules implemented using the machine-learning model and/or may be used to train the machine-learning model, may be provided to a training component 630 that may apply the training data 612 to the training algorithm 620 to generate the machine-learning model. According to one implementation, the training component 630 may be provided comparison results 616 that compare a previous output of the corresponding machine-learning model to apply the previous result to re-train the machine-learning model. The comparison results 616 may be used by training component 630 to update the corresponding machine-learning model. The training algorithm 620 may utilize machine learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, classifiers such as K-Nearest Neighbors, combined learning models, supervised or unsupervised learning models, generative AI or ChatGPT models, and/or discriminative models such as Decision Forests and maximum margin methods, models specifically discussed in the present disclosure, or the like.

The machine-learning model used herein may be trained and/or used by adjusting one or more weights and/or one or more layers of the machine-learning model. For example, during training, a given weight may be adjusted (e.g., increased, decreased, removed) based upon training data or input data. Similarly, a layer may be updated, added, or removed based upon training data/and or input data. The resulting outputs may be adjusted based upon the adjusted weights and/or layers.

In general, any process or operation discussed in this disclosure is understood to be computer-implementable, such as the processes illustrated in FIGS. 2-5 may be performed by one or more processors of a computer system as described herein. A process or process action or operation performed by one or more processors may also be referred to as an operation. The one or more processors may be configured to perform such processes by having access to instructions (e.g., software or computer-readable code) that, when executed by one or more processors, cause the one or more processors to perform the processes. The instructions may be stored in a memory of the computer system. A processor may be a central processing unit (CPU), a graphics processing unit (GPU), or any suitable type of processing unit.

A computer system, such as a system or device implementing a process or operation in the examples above, may include one or more computing devices. One or more processors of a computer system may be included in a single computing device or distributed among a plurality of computing devices. One or more processors of a computer system may be connected to a data storage device. A memory of the computer system may include the respective memory of each computing device of the plurality of computing devices.

### Exemplary Computing Environment

In general, any process or operation discussed in this disclosure is understood to be computer-implementable, such as the processes illustrated in FIGS. 2-6 and may be performed by one or more processors of a computer system as described herein. A process or process action or operation performed by one or more processors may also be referred to as an operation. The one or more processors may be configured to perform such processes by having access to instructions (e.g., software or computer-readable code) that, when executed by one or more processors, cause the one or more processors to perform the processes. The instructions may be stored in a memory of the computer system. A processor may be a central processing unit (CPU), a graphics processing unit (GPU), or any suitable type of processing unit.

A computer system, such as a system or device implementing a process or operation in the examples above, may include one or more computing devices. One or more processors of a computer system may be included in a single computing device or distributed among a plurality of computing devices. One or more processors of a computer system may be connected to a data storage device. A memory of the computer system may include the respective memory of each computing device of the plurality of computing devices.

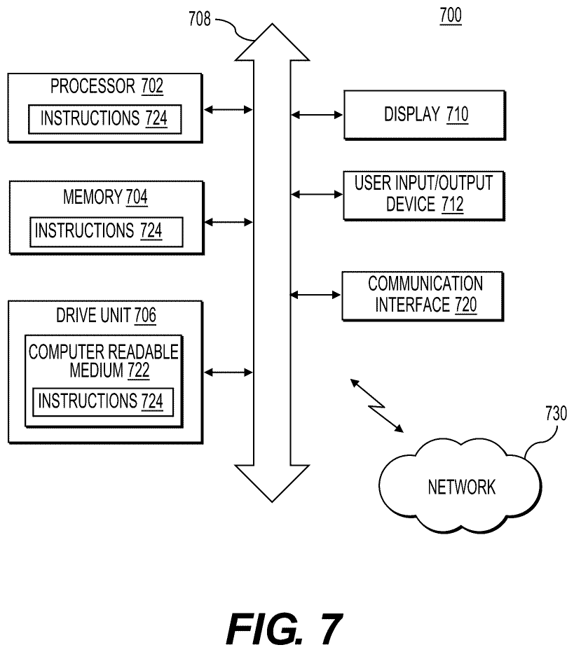

FIG. 7 illustrates an implementation of a computer system that may execute techniques presented herein. The computer system 700 can include a set of instructions that can be executed to cause the computer system 700 to perform any one or more of the methods or computer based functions disclosed herein. The computer system 700 may operate as a standalone device or may be connected, e.g., using a network, to other computer systems or peripheral devices.

Unless specifically stated otherwise, as apparent from the following discussions, it is appreciated that throughout the specification, discussions utilizing terms such as “processing,” “computing,” “calculating,” “determining”, “analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer,” a “computing machine,” a “computing platform,” a “computing device,” or a “server”may include one or more processors.

In a networked deployment, the computer system 700 may operate in the capacity of a server or as a client user computer in a server-client user network environment, or as a peer computer system in a peer-to-peer (or distributed) network environment. The computer system 700 can also be implemented as or incorporated into various devices, such as a personal computer (PC), a tablet PC, a personal digital assistant (PDA), a mobile device, a palmtop computer, a laptop computer, a desktop computer, a web appliance, or any other machine capable of executing a set of instructions (sequential or otherwise) that specify actions to be taken by that machine. In a particular implementation, the computer system 700 may be implemented using electronic devices that provide voice, video, or data communication. Further, while the computer system 700 is illustrated as a single system, the term “system” shall also be taken to include any collection of systems or sub-systems that individually or jointly execute a set, or multiple sets, of instructions to perform one or more computer functions.

As illustrated in FIG. 7, the computer system 700 may include a processor 702, e.g., a central processing unit (CPU), a graphics processing unit (GPU), or both. The processor 702 may be a component in a variety of systems. For example, the processor 702 may be part of a standard personal computer or a workstation. The processor 702 may be one or more processors, digital signal processors, application specific integrated circuits, field programmable gate arrays, servers, networks, digital circuits, analog circuits, combinations thereof, or other now known or later developed devices for analyzing and processing data. The processor 702 may implement a software program, such as code generated manually (i.e., programmed).

The computer system 700 may include a memory 704 that can communicate via bus 708. The memory 704 may be a main memory, a static memory, or a dynamic memory. The memory 704 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 704 may include a cache or random-access memory for the processor 702. In alternative implementations, the memory 704 is separate from the processor 702, such as a cache memory of a processor, the system memory, or other memory.

The memory 704 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 704 is operable to store instructions executable by the processor 702. The functions, acts or tasks illustrated in the figures or described herein may be performed by the processor 702 executing the instructions stored in the memory 704. The functions, acts, or tasks are independent of the particular type of instruction set, storage media, processor or processing strategy and may be performed by software, hardware, integrated circuits, firmware, micro-code and the like, operating alone or in combination. Likewise, processing strategies may include multiprocessing, multitasking, parallel processing, and the like.

As shown, the computer system 700 may further include a display 710, such as a liquid crystal display (LCD), an organic light emitting diode (OLED), a flat panel display, a solid-state display, a cathode ray tube (CRT), a projector, a printer or other now known or later developed display device for outputting determined information. The display 710 may act as an interface for the user to see the functioning of the processor 702, or specifically as an interface with the software stored in the memory 704 or in the drive unit 706.

Additionally or alternatively, the computer system 700 may include an input/output device 712 configured to allow a user to interact with any of the components of the computer system 700. The input/output device 712 may be a number pad, a keyboard, or a cursor control device, such as a mouse, or a joystick, touch screen display, remote control, or any other device operative to interact with the computer system 700.

The computer system 700 may also or alternatively include drive unit 706 implemented as a disk or optical drive. The drive unit 706 may include a computer-readable medium 722 in which one or more sets of instructions 724, e.g., software, can be embedded. Further, instructions 724 may embody one or more of the methods or logic as described herein. The instructions 724 may reside completely or partially within the memory 704 and/or within the processor 702 during execution by the computer system 700. The memory 704 and the processor 702 also may include computer-readable media as discussed above.

In some systems, computer-readable medium 722 may include the set of instructions 724 or receives and executes the set of instructions 724 responsive to a propagated signal so that a device connected to network 730 can communicate voice, video, audio, images, or any other data over the network 730. Further, the set of instructions 724 may be transmitted or received over the network 730 via communication port or interface 720, and/or using bus 708. The communication port or interface 720 may be a part of the processor 702 or may be a separate component. The communication port or interface 720 may be created in software or may be a physical connection in hardware.

The communication port or interface 720 may be configured to connect with a network 730, external media, the display 710, or any other components in computer system 700, or combinations thereof. The connection with the network 730 may be a physical connection, such as a wired Ethernet connection or may be established wirelessly as discussed below. Likewise, the additional connections with other components of the computer system 700 may be physical connections or may be established wirelessly. The network 730 may alternatively be directly connected to the bus 708.

While the computer-readable medium 722 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that causes a computer system to perform any one or more of the methods or operations disclosed herein. The computer-readable medium 722 may be non-transitory, and may be tangible.

The computer-readable medium 722 can include a solid-state memory such as a memory card or other package that houses one or more non-volatile read-only memories. The computer-readable medium 722 can be a random-access memory or other volatile re-writable memory. Additionally or alternatively, the computer-readable medium 722 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

Computer system 700 may be connected to network 730. The network 730 may define one or more networks including wired or wireless networks. The wireless network may be a cellular telephone network, an 802.10, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 730 may include wide area networks (WAN), such as the Internet, local area networks (LAN), campus area networks, metropolitan area networks, a direct connection such as through a Universal Serial Bus (USB) port, or any other networks that may allow for data communication.

The network 730 may be configured to couple one computing device to another computing device to enable communication of data between the devices. The network 730 may generally be enabled to employ any form of machine-readable media for communicating information from one device to another. The network 730 may include communication methods by which information may travel between computing devices.

The network 730 may be divided into sub-networks. The sub-networks may allow access to all of the other components connected thereto or the sub-networks may restrict access between the components. The network 730 may be regarded as a public or private network connection and may include, for example, a virtual private network or an encryption or other security mechanism employed over the public Internet, or the like.

### Exemplary Embodiments

A computer-implemented method for analyzing event data to determine an event pattern, and then determining a user persona based upon the event pattern may be provided. The computer-implemented method may be performed by one or more local or remote processors of a computing system in communication with one or more local or remote data sources.

The computer-implemented method may include (i) receiving, by one or more processors, event data from one or more systems, wherein the event data may include a plurality of site events corresponding to a user; (ii) determining, by the one or more processors, an event mapping based upon the event data, wherein the event mapping corresponds to the plurality of site events; (iii) converting, by the one or more processors, the event mapping into an event numeric array; (iv) converting, by the one or more processors, the event numeric array into an event vector; (v) receiving, by the one or more processors, one or more stored event vectors from one or more data stores; (vi) inputting, by the one or more processors, the one or more stored event vectors and the event vector into one or more trained machine-learning models; (vii) in response to the inputting, receiving, by the one or more processors, a predicted scenario vector from the one or more trained machine-learning models; (viii) receiving, by the one or more processors, one or more stored scenario vectors from the one or more data stores; (ix) inputting, by the one or more processors, the one or more stored scenario vectors and the predicted scenario vector into the one or more trained machine-learning models; (x) in response to the inputting, receiving, by the one or more processors, a scenario embedding from the one or more trained machine-learning models; (xii) predicting, by the one or more processors, a persona marker for the user based upon the scenario embedding; and/or (xii) presenting, by the one or more processors, the persona marker to a user device. The method may include additional, less, or alternate functionality, including that discussed elsewhere herein.

In some embodiments, the voice bots or chatbots may be configured to utilize AI and/or ML techniques, such as for input or output devices. For instance, a voice bot or chatbot may be a ChatGPT chatbot, an InstructGPT bot, a Codex bot, or a Google Bard bot. The voice bot or chatbot may employ supervised or unsupervised ML techniques (or combined techniques, such as supervised ML followed by re-inforcement learning, and/or other generative AI techniques), which may be followed by, and/or used in conjunction with, reinforced or reinforcement learning techniques. The voice bot or chatbot may employ the techniques utilized for ChatGPT, InstructGPT bot, Codex bot, or Google Bard bot.

For instance, the event numeric array may include a variable length, and wherein the event vector may include a standard length.

In certain aspects, determining the event mapping may include enumerating, by the one or more processors, the event data. Additionally or alternatively, the event mapping may include a plurality of nodes, and each of the plurality of nodes may correspond to at least one of the plurality of site events.

In certain embodiments, determining the event mapping may include (i) correlating, by the one or more processors, each of the plurality of nodes by identifying a connection between each of the plurality of nodes, wherein the correlating may include determining a node sequence; (ii) predicting, by the one or more processors, at least one label for each of the plurality of nodes, wherein the at least one label corresponds to an event definition; (iii) determining, by the one or more processors, at least one event probability for each of the plurality of nodes; and/or (iv) storing, by the one or more processors, the correlated plurality of nodes, the at least one label for each of the plurality of nodes, and the at least one event probability for each of the plurality of nodes in the one or more data stores.

Additionally or alternatively, determining the at least one event probability for each of the plurality of nodes may include deriving, by the one or more processors, one or more probability maps from the correlated plurality of nodes.

In certain aspects, predicting the at least one label for each of the plurality of nodes may include utilizing, by the one or more processors, a Graph Neural Network to perform the predicting of the at least one label for each of the plurality of nodes.

In some embodiments, the computer-implemented method may include (i) sending, by the one or more processors, the persona marker to a data store; (ii) in response to the sending, receiving, by the one or more processors, a persona template from the data store, wherein the persona template corresponds to the persona marker; (iii) creating, by the one or more processors, an electronic communication based upon the persona template; and/or (iv) sending, by the one or more processors, the electronic communication to the user device.

In certain aspects, the computer-implemented method may include (i) inputting, by the one or more processors, the persona marker into a trained machine-learning model, wherein the trained machine-learning model is configured to create an electronic communication based upon the persona marker; (ii) receiving, by the one or more processors, the electronic communication from the trained machine-learning model; and/or (iii) sending, by the one or more processors, the electronic communication to the user device.

Additionally or alternatively, the computer-implemented method may include (i) receiving, by the one or more processors, a feedback indicator from the user device, wherein the feedback indicator corresponds to an accuracy of the persona marker; and/or (ii) tuning, by the one or more processors, the one or more trained machine-learning models based upon the feedback indicator.

In some embodiments, the persona marker may correspond to a resistant marker, an ambivalent marker, a self-sufficient marker, or a receptive marker.

A computer system for analyzing event data to determine an event pattern, and then determining a user persona based upon the event pattern may be provided. The computer system may include (i) a memory having processor-readable instructions stored therein; and/or (ii) one or more processors configured to access the memory and execute the processor-readable instructions, which when executed by the one or more processors configures the one or more processors to perform a plurality of functions.

The functions may include (i) receiving, by the one or more processors, event data from one or more systems, wherein the event data may include a plurality of site events corresponding to a user; (ii) determining, by the one or more processors, an event mapping based upon the event data, wherein the event mapping corresponds to the plurality of site events; (iii) converting, by the one or more processors, the event mapping into an event numeric array; (iv) converting, by the one or more processors, the event numeric array into an event vector; (v) receiving, by the one or more processors, one or more stored event vectors from one or more data stores; (vi) inputting, by the one or more processors, the one or more stored event vectors and the event vector into one or more trained machine-learning models; (vii) in response to the inputting, receiving, by the one or more processors, a predicted scenario vector from the one or more trained machine-learning models; (viii) receiving, by the one or more processors, one or more stored scenario vectors from the one or more data stores; (ix) inputting, by the one or more processors, the one or more stored scenario vectors and the predicted scenario vector into the one or more trained machine-learning models; (x) in response to the inputting, receiving, by the one or more processors, a scenario embedding from the one or more trained machine-learning models; (xii) predicting, by the one or more processors, a persona marker for the user based upon the scenario embedding; and/or (xii) presenting, by the one or more processors, the persona marker to a user device.

In some embodiments, voice bots or chatbots may be configured to utilize AI and/or ML techniques, such as for input or output devices. For instance, a voice bot or chatbot may be a ChatGPT chatbot, an InstructGPT bot, a Codex bot, or a Google Bard bot. The voice bot or chatbot may employ supervised or unsupervised ML techniques, which may be followed by, and/or used in conjunction with, reinforced or reinforcement learning techniques. The voice bot or chatbot may employ the techniques utilized for ChatGPT, InstructGPT bot, Codex bot, or Google Bard bot.

For instance, the event numeric array may include a variable length, and wherein the event vector may include a standard length.

In certain aspects, determining the event mapping may include enumerating, by the one or more processors, the event data. Additionally or alternatively, the event mapping may include a plurality of nodes, and wherein each of the plurality of nodes corresponds to at least one of the plurality of site events.

In certain embodiments, determining the event mapping may include (i) correlating, by the one or more processors, each of the plurality of nodes by identifying a connection between each of the plurality of nodes, wherein the correlating may include determining a node sequence; (ii) predicting, by the one or more processors, at least one label for each of the plurality of nodes, wherein the at least one label corresponds to an event definition; (iii) determining, by the one or more processors, at least one event probability for each of the plurality of nodes; and/or (iv) storing, by the one or more processors, the correlated plurality of nodes, the at least one label for each of the plurality of nodes, and the at least one event probability for each of the plurality of nodes in the one or more data stores.

A non-transitory computer-readable medium containing instructions for analyzing event data to determine an event pattern, and then determining a user persona based upon the event pattern may be provided. The instructions may include (i) receiving, by the one or more processors, event data from one or more systems, wherein the event data may include a plurality of site events corresponding to a user; (ii) determining, by the one or more processors, an event mapping based upon the event data, wherein the event mapping corresponds to the plurality of site events; (iii) converting, by the one or more processors, the event mapping into an event numeric array; (iv) converting, by the one or more processors, the event numeric array into an event vector; (v) receiving, by the one or more processors, one or more stored event vectors from one or more data stores; (vi) inputting, by the one or more processors, the one or more stored event vectors and the event vector into one or more trained machine-learning models; (vii) in response to the inputting, receiving, by the one or more processors, a predicted scenario vector from the one or more trained machine-learning models; (viii) receiving, by the one or more processors, one or more stored scenario vectors from the one or more data stores; (ix) inputting, by the one or more processors, the one or more stored scenario vectors and the predicted scenario vector into the one or more trained machine-learning models; (x) in response to the inputting, receiving, by the one or more processors, a scenario embedding from the one or more trained machine-learning models; (xii) predicting, by the one or more processors, a persona marker for the user based upon the scenario embedding; and/or (xii) presenting, by the one or more processors, the persona marker to a user device.

In some embodiments, voice bots or chatbots may be configured to utilize AI and/or ML techniques, such as for input or output devices. For instance, a voice bot or chatbot may be a ChatGPT chatbot, an InstructGPT bot, a Codex bot, or a Google Bard bot. The voice bot or chatbot may employ supervised or unsupervised ML techniques, which may be followed by, and/or used in conjunction with, reinforced or reinforcement learning techniques. The voice bot or chatbot may employ the techniques utilized for ChatGPT, InstructGPT bot, Codex bot, or Google Bard bot.

In certain aspects, the instructions may include (i) inputting, by the one or more processors, the persona marker into a trained machine-learning model, wherein the trained machine-learning model is configured to create an electronic communication based upon the persona marker; (ii) receiving, by the one or more processors, the electronic communication from the trained machine-learning model; and/or (iii) sending, by the one or more processors, the electronic communication to the user device.

Additionally or alternatively, the instructions may include (i) receiving, by the one or more processors, a feedback indicator from the user device, wherein the feedback indicator corresponds to an accuracy of the persona marker; and/or (ii) tuning, by the one or more processors, the one or more trained machine-learning models based upon the feedback indicator.

In some embodiments, the persona marker may correspond to a resistant marker, an ambivalent marker, a self-sufficient marker, or a receptive marker.

### Additional Considerations

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the actions, operations, and/or functionality of computer-implemented methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘_______’ is hereby defined to mean. . .” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Finally, unless a claim element is defined by expressly reciting the word “means” and a function without the recital of any structure, it is not intended that the scope of any claim element be interpreted based upon the application of 35 U.S.C. § 112(f).

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in exemplary configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied upon a non-transitory, tangible machine-readable medium) or hardware. In hardware, the routines, etc., are tangible units capable of performing certain operations and may be configured or arranged in a certain manner. In exemplary embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled.

A further hardware module may then, at a later time, access the memory device to retrieve and process the stored output. Hardware modules may also initiate communications with input or output devices, and can operate upon a resource (e.g., a collection of information).

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some exemplary embodiments, comprise processor-implemented modules.

Similarly, the methods or routines described herein may be at least partially processor-implemented. For example, at least some of the operations of a method may be performed by one or more processors or processor-implemented hardware modules.

The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “include,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

Upon reading this disclosure, those of skill in the art will appreciate still additional alternative structural and functional designs for the approaches described herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

What is claimed is:

1. A computer-implemented method for analyzing event data to determine an event pattern, and then determining a user persona based upon the event pattern, the computer-implemented method comprising:
receiving, by one or more processors, event data from one or more systems, wherein the event data includes a plurality of site events corresponding to a user;
determining, by the one or more processors, an event mapping based upon the event data, wherein the event mapping corresponds to the plurality of site events;
converting, by the one or more processors, the event mapping into an event numeric array;
converting, by the one or more processors, the event numeric array into an event vector;
receiving, by the one or more processors, one or more stored event vectors from one or more data stores;
inputting, by the one or more processors, the one or more stored event vectors and the event vector into one or more trained machine-learning models;
in response to the inputting, receiving, by the one or more processors, a predicted scenario vector from the one or more trained machine-learning models;
receiving, by the one or more processors, one or more stored scenario vectors from the one or more data stores;
inputting, by the one or more processors, the one or more stored scenario vectors and the predicted scenario vector into the one or more trained machine-learning models;
in response to the inputting, receiving, by the one or more processors, a scenario embedding from the one or more trained machine-learning models;
predicting, by the one or more processors, a persona marker for the user based upon the scenario embedding; and
presenting, by the one or more processors, the persona marker to a user device.

2. The computer-implemented method of claim 1, wherein the event numeric array includes a variable length, and wherein the event vector includes a standard length.

3. The computer-implemented method of claim 1, wherein the determining the event mapping further comprises:
enumerating, by the one or more processors, the event data.

4. The computer-implemented method of claim 1, wherein the event mapping includes a plurality of nodes, and wherein each of the plurality of nodes corresponds to at least one of the plurality of site events.

5. The computer-implemented method of claim 4, wherein the determining the event mapping further comprises:
correlating, by the one or more processors, each of the plurality of nodes by identifying a connection between each of the plurality of nodes, wherein the correlating includes determining a node sequence;
predicting, by the one or more processors, at least one label for each of the plurality of nodes, wherein the at least one label corresponds to an event definition;
determining, by the one or more processors, at least one event probability for each of the plurality of nodes; and
storing, by the one or more processors, the correlated plurality of nodes, the at least one label for each of the plurality of nodes, and the at least one event probability for each of the plurality of nodes in the one or more data stores.

6. The computer-implemented method of claim 5, wherein the determining the at least one event probability for each of the plurality of nodes further includes:
deriving, by the one or more processors, one or more probability maps from the correlated plurality of nodes.

7. The computer-implemented method of claim 5, wherein predicting the at least one label for each of the plurality of nodes includes:
utilizing, by the one or more processors, a Graph Neural Network to perform the predicting of the at least one label for each of the plurality of nodes.

8. The computer-implemented method of claim 1, wherein the presenting the persona marker to a user device includes:
sending, by the one or more processors, the persona marker to a data store;
in response to the sending, receiving, by the one or more processors, a persona template from the data store, wherein the persona template corresponds to the persona marker;
creating, by the one or more processors, an electronic communication based upon the persona template; and
sending, by the one or more processors, the electronic communication to the user device.

9. The computer-implemented method of claim 1, the computer-implemented method further comprising:
inputting, by the one or more processors, the persona marker into a trained machine-learning model, wherein the trained machine-learning model is configured to create an electronic communication based upon the persona marker;
receiving, by the one or more processors, the electronic communication from the trained machine-learning model; and
sending, by the one or more processors, the electronic communication to the user device.

10. The computer-implemented method of claim 1, the computer-implemented method further comprising:
receiving, by the one or more processors, a feedback indicator from the user device, wherein the feedback indicator corresponds to an accuracy of the persona marker; and
tuning, by the one or more processors, the one or more trained machine-learning models based upon the feedback indicator.

11. The computer-implemented method of claim 1, wherein the persona marker corresponds to a resistant marker, an ambivalent marker, a self-sufficient marker, or a receptive marker.

12. A computer system for analyzing event data to determine an event pattern, and then determining a user persona based upon the event pattern, the computer system comprising:
a memory having processor-readable instructions stored therein; and
one or more processors configured to access the memory and execute the processor-readable instructions, which when executed by the one or more processors configures the one or more processors to perform a plurality of functions, including functions for:
receiving, by the one or more processors, event data from one or more systems, wherein the event data includes a plurality of site events corresponding to a user;
determining, by the one or more processors, an event mapping based upon the event data, wherein the event mapping corresponds to the plurality of site events;
converting, by the one or more processors, the event mapping into an event numeric array;
converting, by the one or more processors, the event numeric array into an event vector;
receiving, by the one or more processors, one or more stored event vectors from one or more data stores;
inputting, by the one or more processors, the one or more stored event vectors and the event vector into one or more trained machine-learning models;
in response to the inputting, receiving, by the one or more processors, a predicted scenario vector from the one or more trained machine-learning models;
receiving, by the one or more processors, one or more stored scenario vectors from the one or more data stores;
inputting, by the one or more processors, the one or more stored scenario vectors and the predicted scenario vector into the one or more trained machine-learning models;
in response to the inputting, receiving, by the one or more processors, a scenario embedding from the one or more trained machine-learning models;
predicting, by the one or more processors, a persona marker for the user based upon the scenario embedding; and
presenting, by the one or more processors, the persona marker to a user device.

13. The computer system of claim 12, wherein the event numeric array includes a variable length, and wherein the event vector includes a standard length.

14. The computer system of claim 12, wherein the determining the event mapping further comprises:
enumerating, by the one or more processors, the event data.

15. The computer system of claim 12, wherein the event mapping includes a plurality of nodes, and wherein each of the plurality of nodes corresponds to at least one of the plurality of site events.

16. The computer system of claim 15, wherein the determining the event mapping further comprises:
correlating, by the one or more processors, each of the plurality of nodes by identifying a connection between each of the plurality of nodes, wherein the correlating includes determining a node sequence;
predicting, by the one or more processors, at least one label for each of the plurality of nodes, wherein the at least one label corresponds to an event definition;
determining, by the one or more processors, at least one event probability for each of the plurality of nodes; and
storing, by the one or more processors, the correlated plurality of nodes, the at least one label for each of the plurality of nodes, and the at least one event probability for each of the plurality of nodes in the one or more data stores.

17. A non-transitory computer-readable medium containing instructions for analyzing event data to determine an event pattern, and then determining a user persona based upon the event pattern, the instructions comprising:
receiving, by one or more processors, event data from one or more systems, wherein the event data includes a plurality of site events corresponding to a user;
determining, by the one or more processors, an event mapping based upon the event data, wherein the event mapping corresponds to the plurality of site events;
converting, by the one or more processors, the event mapping into an event numeric array;
converting, by the one or more processors, the event numeric array into an event vector;
receiving, by the one or more processors, one or more stored event vectors from one or more data stores;
inputting, by the one or more processors, the one or more stored event vectors and the event vector into one or more trained machine-learning models;
in response to the inputting, receiving, by the one or more processors, a predicted scenario vector from the one or more trained machine-learning models;
receiving, by the one or more processors, one or more stored scenario vectors from the one or more data stores;
inputting, by the one or more processors, the one or more stored scenario vectors and the predicted scenario vector into the one or more trained machine-learning models;
in response to the inputting, receiving, by the one or more processors, a scenario embedding from the one or more trained machine-learning models;
predicting, by the one or more processors, a persona marker for the user based upon the scenario embedding; and
presenting, by the one or more processors, the persona marker to a user device.

18. The non-transitory computer-readable medium of claim 17, the instructions further comprising:
inputting, by the one or more processors, the persona marker into a trained machine-learning model, wherein the trained machine-learning model is configured to create an electronic communication based upon the persona marker;
receiving, by the one or more processors, the electronic communication from the trained machine-learning model; and
sending, by the one or more processors, the electronic communication to the user device.

19. The non-transitory computer-readable medium of claim 17, the instructions further comprising:
receiving, by the one or more processors, a feedback indicator from the user device, wherein the feedback indicator corresponds to an accuracy of the persona marker; and
tuning, by the one or more processors, the one or more trained machine-learning models based upon the feedback indicator.

20. The non-transitory computer-readable medium of claim 17, wherein the persona marker corresponds to a resistant marker, an ambivalent marker, a self-sufficient marker, or a receptive marker.
